(19) United States
(12) Patent Application Publication
(10) Pub. No.: US 2024/0155969 A1
(43) Pub. Date: May 16, 2024

(54) Method for Controlling an Agricultural Spreading Machine

(71) Applicant: Amazonen-Werke H. Dreyer SE & Co. KG, Hasbergen (DE)

(72) Inventor: Herbert BÄUMKER, Hilter (DE)

(73) Assignee: Amazonen-Werke H. Dreyer SE & Co. KG, Hasbergen (DE)

(21) Appl. No.: 18/282,312

(22) PCT Filed: Mar. 8, 2022
(86) PCT No.: PCT/EP22/55783

§ 371 Date: Sep. 15, 2023

(30) Foreign Application Priority Data
Mar. 18, 2021 (DE) 10 2021 106 602.6

(51) Int. Cl. A01C 17/00

(52) U.S. Cl. CPC A01C 17/008; A01C 17/001

(57) ABSTRACT

A method for controlling an agricultural spreading machine during the discharging of spreading material on an agricultural area, comprising: using a conveyor belt of the spreading machine to feed the spreading material to be discharged along an idling section, which relates to a longitudinal section of the conveyor belt, wherein the idling section lies between a rate-setting plane, in which the feed rate of spreading material entering the idling section is set by a feed-rate-setting device of the spreading machine, and an ejection plane, in which the feed rate of spreading material leaving the idling section is ejected from the conveyor belt in the direction of a first and a second spreading disc.

### CROSS REFERENCE TO RELATED APPLICATIONS

The present application claims priority under 35 U.S.C. § 365 to PCT/EP2022/055783 filed on Mar. 8, 2022 and under 35 U.S.C. § 119(a) to German Application No. 10 2021 106 602.6 filed on Mar. 18, 2021.

### BACKGROUND

The invention relates to a method for controlling an agricultural spreading machine and a spreading system for distributing spreading material.

Trailed spreading machines able to carry a comparatively large quantity of spreading material due to a large-volume storage tank are regularly used to distribute spreading material on large agricultural areas. Such spreading machines often have a conveyor belt for conveying the spreading material, by means of which the spreading material is transported in the direction of the spreading discs and discharged from the conveyor belt in the direction of the spreading discs in a ejection plane.

For quantity adjustment of the spreading material fed onto the spreading discs, slide systems are used in practice, with which the free conveying cross-section above the conveyor belt may be adjusted. Such slide systems have a main slide, with which the quantity may be preset. Two hydraulically actuated closing slides may be arranged downstream of the main slide and in the vicinity of the ejection plane of the conveyor belt, by means of which the feed of the spreading material onto the spreading discs may be prevented individually for each disc.

The known solutions for quantity adjustment on spreading machines, in which a conveyor belt is used to convey the spreading material, have two disadvantages in particular. In wedge spreading, one of the two closing slides is initially closed, so that the spreading material collects in front of the closed slide due to the continuing conveyor belt. When the closing slide is subsequently opened, for example in the next lane, the accumulation of spreading material in front of the closing slide and the flowability of the spreading material cause an excessive amount of spreading material to be fed onto the spreading disc, resulting in localized misapplication. Especially when discharging spreading material on comparatively long wedge-shaped surface sections, an overflow of the spreading material over the closing slide or its upper boundary edge may even occur, whereby spreading material reaches the spreading discs and/or the working surface in an uncontrolled manner. Preventing such an overflow is extremely costly due to design-related specifications, as it is then no longer possible to implement an upstream quantity adjustment.

From EP 1 869 962 B1 there is known a metering system operating without a main slide. In the case of the discharging of spreading material described there, however, when the discharge of spreading material is temporarily interrupted by stopping the conveyor belt, spreading material lies in the immediate vicinity of the ejection plane at least on a partial width of the conveyor belt. When the belt conveying is continued, spreading material is then inevitably fed directly onto the spreading disc on this side, regardless of whether this is intended or not. For this reason, unintentional discharging of spreading material on the inside of a curve at the end of a turning operation in the headland cannot be avoided, so that over-fertilization occurs in the inside of the curve during every turning operation between two parallel runs. Due to the fact that spreading material is in the immediate vicinity of the ejection plane during the temporary interruption of the discharge of spreading material, there is also a risk that spreading material will fall uncontrollably onto the spreading disc and/or the working surface during bumpy driving, for example due to uneven ground.

In order to overcome the problems described above, spreading machines are also used in practice, which instead of spreading discs have a spreading linkage with a plurality of spreading elements, whereby the spreading material is conveyed pneumatically in these machines. Such a spreading machine is known, for example, from EP 3 662 734 A1.

### SUMMARY

The object to be addressed by the disclosure is thus to at least partially overcome the aforementioned disadvantages in discharging spreading material with an agricultural spreading machine, in which a conveyor belt is used to convey the spreading material.

The object is solved by a method as referred to at the beginning, wherein a control device within the scope of the method according to the disclosure for temporarily interrupting the discharging of spreading material at a shut-off location on the agricultural area causes the feed-rate-setting device to prevent the discharging of spreading material into the idling section at an early stage before the shut-off location is reached, so that the idling section of the conveyor belt has run empty when the shut-off location is reached.

After the temporary interruption in discharging, there is no spreading material in the vicinity of the ejection plane, as the idling section has already run empty. As a result, there is no risk of spreading material falling unintentionally onto the spreading disc during bumpy driving. Furthermore, when discharging of spreading material is continued, there is no spreading material in the vicinity of the ejection plane. Thus, when the discharging of spreading material continues after or during a turning operation, there is never any spreading material on the wrong side of the idling section, so that no unintentional local excessive or insufficient discharging of spreading material occurs. If the spreading material is fertilizer, over-fertilization or under-fertilization is effectively avoided when performing turning operations, such as on the headland. This may also significantly reduce the risk of spreading in hazardous areas, for example at a field boundary or at a body of water.

The control device may be part of the spreading machine. Alternatively, the control device may be a device external to the machine. The control device may, for example, be a terminal, in particular an Isobus terminal, which is connected to the spreading machine in a signal-conducting manner. The temporary interruption of the discharging of spreading material takes place, for example, at the transition to the headland or at the end of a wedge spreading operation. The spreading material is conveyed by means of the conveyor belt from a reservoir in the direction of the spreading discs. The conveyor belt is preferably of a revolving design. The conveyor belt preferably has a belt drive. The spreading discs are preferably arranged side by side. The operation of the conveyor belt and the feed-rate-setting device is preferably controlled by means of the control device.

In a preferred embodiment of the method according to the disclosure, the control device for continuing the discharging of spreading material at a switch-on location on the agricultural area causes the feed-rate-setting device to trigger the conveying of spreading material into the idling section early before the switch-on location is reached, so that the conveyor belt is loaded with spreading material along the entire idling section at least over a partial width when the switch-on location is reached. When the switch-on location is reached, at least part of the width of the idling section is thus loaded with spreading material up to the ejection plane, so that the spreading material may be fed to the spreading discs immediately without delay when the switch-on location is passed.

In a further preferred embodiment of the method according to the disclosure, the spreading material leaving the idling section and located on a first partial width of the idling section is discharged from the conveyor belt in the ejection plane in the direction of a first spreading disc of the spreading machine. Alternatively or additionally, the spreading material leaving the idling section and located on a second partial width of the idling section is discharged from the conveyor belt in the ejection plane in the direction of a second spreading disc of the spreading machine. The first partial width of the idling section is thus assigned to a first spreading disc, the second partial width of the idling section being assigned to a second spreading disc. In this respect, the feed of spreading material to the first spreading disc may be adjusted via the loading of the first partial width of the idling section, while the feed of spreading material to the second spreading disc may be adjusted via the loading of the second partial width of the idling section.

In a further embodiment of the method according to the disclosure, the feed-rate-setting device sets the feed quantity of spreading material entering a first partial width of the idling section in the feed setting plane by means of a first feed-rate limiter. Alternatively or additionally, the feed-rate-setting device sets the feed quantity of spreading material entering a second partial width of the idling section in the feed setting plane by means of a second feed-rate limiter. The partial widths of the idling section are partial widths of the idling section, for example, the first partial width of the idling section is the left side and the second partial width of the idling section is the right side of the idling section. Preferably, the feed quantity limiters each include a feed slide that may be lowered onto the conveyor belt and lifted off the conveyor belt. The feed-rate-setting device may thus be a double slide device. The feed slides are preferably each connected to a slide drive, by means of which the respective feed slide may be raised and lowered. The slide drives may preferably be controlled independently of one another. The slide drives may be electric drives. Alternatively, the slide drives may be pneumatic or hydraulic drives. By means of the slide drives, the free feed cross-section above the conveyor belt may preferably be adjusted in the inlet area of the first partial width of the idling section and in the inlet area of the second partial width of the idling section.

In addition, it is advantageous to have a method in which, at a spreading boundary of the agricultural area extending at right angles to the direction of travel of the spreading machine, the control device, when temporarily interrupting the discharging of spreading material at a shut-off location on the agricultural area, simultaneously causes the first feed rate limiter and the second feed rate limiter of the feed-rate-setting device to close at a common time, to prevent spreading material from being conveyed into the first partial width of the idling section and the second partial width of the idling section early before the shut-off location is reached, so that the first partial width of the idling section and the second partial width of the idling section run empty synchronously before the shut-off location is reached. A spreading boundary running at right angles to the direction of travel of the spreading machine results in particular in the transition areas to the headland, in which the headland lane runs at right angles to the lanes inside the field. As the first idling section and the second idling section run synchronously empty before reaching the shut-off location, spreading is interrupted synchronously on both sides.

In a further preferred embodiment of the method according to the disclosure, the control device, at a spreading boundary of the agricultural area extending obliquely to the direction of travel of the spreading machine, causes the first feed rate limiter of the feed-rate-setting device to close at a first time and the second feed rate limiter of the feed-rate-setting device to close at a second time, with a time delay from one another, when spreading is temporarily interrupted at a shut-off location on the agricultural area, to prevent the conveyance of spreading material into the first partial width of the idling section and the second partial width of the idling section early before the shut-off location is reached, so that the first partial width of the idling section and the second partial width of the idling section idle asynchronously before the shut-off location is reached. As a result of the asynchronous idling of the first partial width of the idling section and the second partial width of the idling section, spreading is first interrupted on one side before the entire spreading process is interrupted. If the spreading boundary runs diagonally to the direction of travel of the spreading machine, for example, a wedge spreading situation or a diagonally running headland is present.

In a further embodiment of the method according to the disclosure, the control device calculates the common closing time in the case of a spreading boundary of the agricultural area running at right angles to the direction of travel of the spreading machine as a function of an intended travel speed until the shut-off location is reached. Alternatively or additionally, the control device calculates the first closing time and/or the second closing time for a spreading boundary of the agricultural area running obliquely to the direction of travel of the spreading machine as a function of an intended travel speed until the shut-off location is reached. Furthermore, the control device takes into account the current position and/or the position of the shut-off location or the distance to the shut-off location when calculating the closing time. Furthermore, when calculating the closing time, the control device may also take into account the duration until the shut-off location is reached, which results from the distance to the shut-off location and the travel speed until the shut-off location is reached. A satellite navigation system may be used to determine the position, for example GPS or DGPS.

The control device may calculate the common closing time or the first closing time and/or the second closing time alternatively or additionally also taking into account the actual or current travel speed or taking into account a selected travel speed.

In a further preferred embodiment of the method according to the disclosure, the first feed rate limiter and the second feed rate limiter of the feed-rate-setting device each perform a closing process for completely preventing the feed of spreading material into the first partial width of the idling section and the second partial width of the idling section, the closing process extending over a closing period. The conveyed quantity of spreading material entering the first partial width of the idling section drops due to the closing process of the first feed rate limiter during the closing time of the first feed rate limiter. Alternatively or additionally, the conveyed quantity of spreading material entering the second partial width of the idling section drops due to the closing process of the second feed rate limiter during the closing time of the second feed rate limiter. During the closing period, there is an increasing blocking of the free feed cross-section in the inlet area of the partial width of the idling sections by the respective feed rate limiter, so that a loading ramp is created on the partial width of the idling sections during the closing process. During the closing process, the loading ramp drops in the opposite direction to the conveying direction. Opening processes of the first feed rate limiter and the second feed rate limiter also extend over an opening duration, wherein a loading ramp also is obtained for the partial width of the idling sections during the opening process. During the opening process, however, the loading ramp drops in the conveying direction.

In another preferred embodiment of the method according to the disclosure, the control device adapts the belt speed of the conveyor belt during the closing process of the first and/or the second feed rate limiter to the falling feed quantity of spreading material on the first partial width of the idling section and/or the second partial width of the idling section. Preferably, the belt speed increases with decreasing feed quantity of spreading material on the first partial width of the idling section and/or the second partial width of the idling section. When adjusting the belt speed of the conveyor belt, the control device preferably also takes into account the spread pattern to be produced, the travel speed and/or the closing speed of the first and/or the second feed rate limiters.

Furthermore, a method according to the disclosure is advantageous, in which the feed-rate-setting device adjusts the feed quantity of spreading material entering the idling section by partially or completely blocking the free feed cross-section above the conveyor belt. The adjustment of the free feed cross-section above the conveyor belt is preferably carried out by lowering and raising the feed slides of the feed rate limiters.

The problem to be addressed by the disclosure is further solved by a spreading system of the type referred to at the beginning, wherein the spreading system according to the disclosure has a control device that is configured to cause, for the temporary interruption of the discharging of spreading material at a shut-off location on the agricultural area, the feed-rate-setting device to prevent the delivery of spreading material into the idling section early before the shut-off location is reached, so that the idling section of the conveyor belt has run empty when the shut-off location is reached.

In a preferred embodiment, the spreading system according to the disclosure is configured to perform the method of controlling an agricultural spreading machine during the spreading or discharging of spreading material on an agricultural land according to any of the embodiments described above. With respect to the advantages and modifications of the spreading system according to the disclosure, reference is thus made to the advantages and modifications of the method according to the disclosure.

### BRIEF DESCRIPTION OF THE DRAWINGS

In the following, preferred embodiments of the invention are explained and described in more detail with reference to the accompanying figures. In the figures:

FIG. 1 shows an embodiment of the spreading system according to the disclosure in a perspective view;

FIG. 2 shows an additional embodiment of the spreading system according to the disclosure in a plan view;

FIG. 3 shows an agricultural spreading machine during discharging of spreading material, wherein the agricultural spreading machine is controlled by the method according to the disclosure;

FIG. 4 depicts an agricultural spreading machine during discharging of spreading material, wherein the agricultural spreading machine is controlled by the method according to the disclosure;

FIG. 5A illustrates spreading material loading state of a partial width of the idling section including the feed rate limiter during spreading of spreading material;

FIG. 6 shows a further spreading material loading state of a partial width of the idling section together with the feed rate limiter during discharging of spreading material;

FIG. 7 shows another spreading material loading state of a partial width of the idling section together with the feed rate limiter during discharging of spreading material;

FIG. 8 shows a further spreading material loading state of a partial width of the idling section including the feed rate limiter during discharging of spreading material; and

FIG. 9 shows a further spreading material loading state of a partial width of the idling section together with the feed rate limiter during discharging of spreading material.

### DETAILED DESCRIPTION

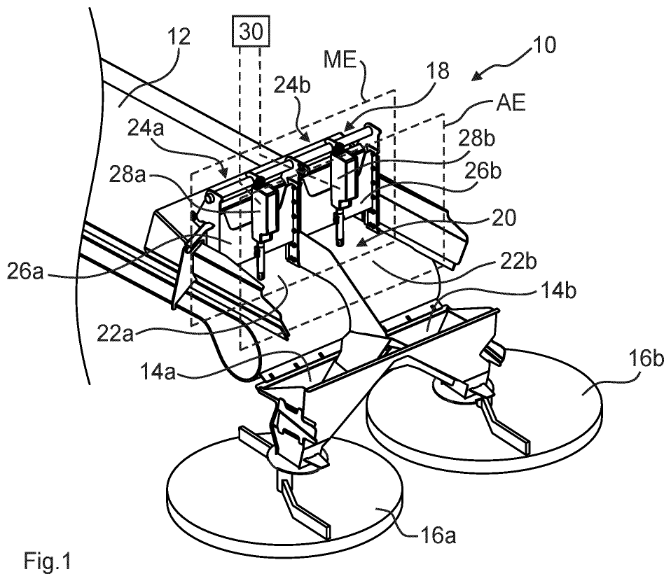

FIG. 1 shows a spreading system 10 for discharging spreading material S on an agricultural area. The spreading system 10 may, for example, be a component of an agricultural spreading machine, the agricultural spreading machine being, for example, a twin-disc fertilizer spreading machine.

The spreading system 10 includes a conveyor belt 12, by means of which spreading material may be transported from a reservoir to a first spreading disc 16a and a second spreading disc 16b. The conveyor belt 12 conveys the spreading material S to be discharged along an idling section 20 relating to a longitudinal section LA of the conveyor belt 12, which lies between a rate setting plane ME and an ejection plane AE. The feed quantity of spreading material S leaving the idling section 20 is discharged in the ejection plane AE in the direction of the spreading discs 16a, 16b. Guide bodies 14a, 14b are arranged between the conveyor belt 12 and the spreading discs 16a, 16b, which are designed as funnels and bring together the spreading material S leaving the conveyor belt 12 before it hits the spreading discs 16a, 16b.

The spreading system 10 further includes a feed-rate-setting device 18, by means of which the delivery rate of spreading material S entering the idling section 20 may be set in the rate setting plane ME.

The idling section 20 is divided into a first partial width 22a of the idling section and a second partial width 22b of the idling section. The spreading material S leaving the idling section 20 and located on the first partial width 22a of the idling section is discharged from the conveyor belt 12 in the ejection plane AE in the direction of the first spreading disc 16a. The spreading material S leaving the idling section 20 and located on the second partial width 22b of the idling section is discharged from the conveyor belt 12 in the ejection plane AE in the direction of the second spreading disc 16b.

The feed-rate-setting device 18 has a first feed rate limiter 24a arranged in the rate setting plane ME. By means of the first feed rate limiter 24a, the feed rate of spreading material S entering the first partial width 22a of the idling section may be adjusted. The feed-rate-setting device 18 further includes a second feed rate limiter 24b in the rate setting plane ME, by means of which the feed quantity of spreading material S entering the second partial width 22b of the idling section may be set.

The feed rate limiters 24a, 24b each include a feed slide 26a, 26b which may be lowered onto and raised from the conveyor 12. The feed slides 26a, 26b are each connected to a slide drive 28a, 28b by which the respective feed slide 26a, 26b may be raised and lowered. The slide drives 28a, 28b are electric drives.

The slide drives 28a, 28b and the belt drive of the conveyor belt 12 are connected in a signal-conducting manner to a control device 30 of the spreading system 10. The control device 30 may be an internal machine control device or an external machine control device. For example, the control device 30 is a terminal, in particular an isobus terminal.

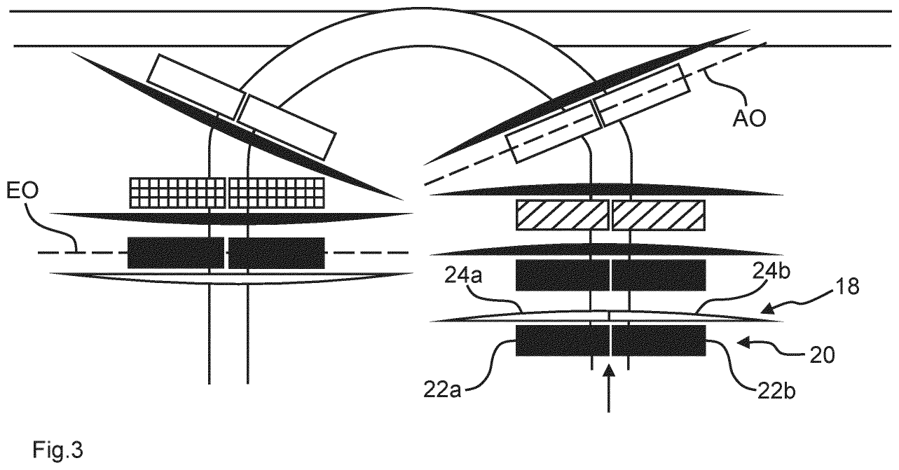

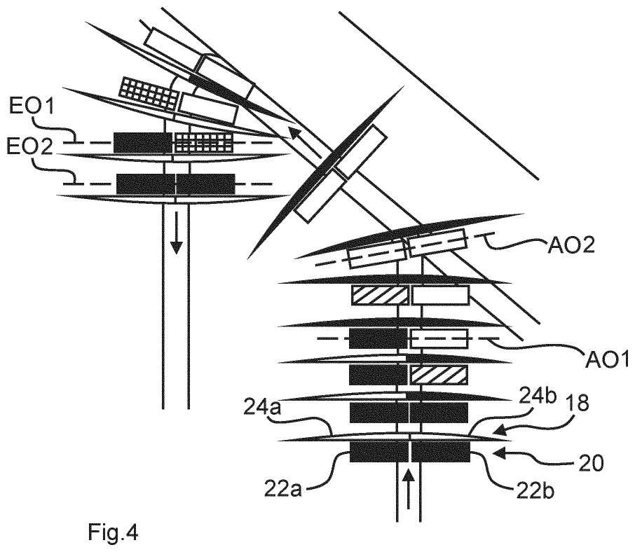

The control device 30 is configured to cause the feed-rate-setting device 18 to prevent the transport of spreading material S into the idling section 20 at an early stage before the shut-off location AO, AO2 (cf. FIGS. 3 and 4) is reached, so that the idling section 20 of the conveyor belt 12 is idled when the shut-off location AO, AO2 is reached. Furthermore, the control device 30 is arranged to cause the feed-rate-setting device to trigger the feed of spreading material S into the idling section 20 early before the switch-on location EO, EO1 (cf. FIGS. 3 and 4) is reached, so that the conveyor belt 12 is loaded with spreading material S over at least a partial width along the entire idling section 20 when the switch-on location EO, EO1 is reached.

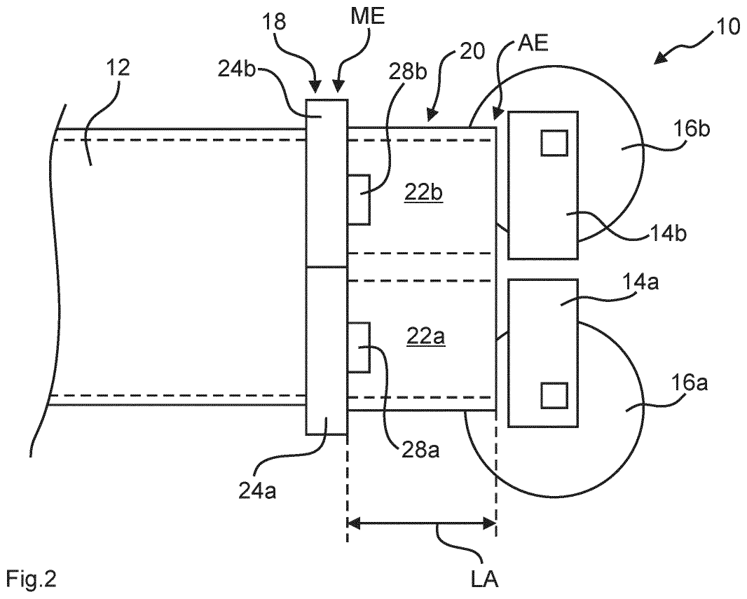

FIG. 2 shows that the partial widths 22a, 22b of the idling sections are adjacent partial widths of the idling sections 20, which extend along a longitudinal section LA of the conveyor belt 12. The longitudinal section LA is located between the rate setting plane ME and the ejection plane AE.

FIG. 3 shows a headland situation, in which a spreading boundary runs at right angles to the direction of travel of the spreading machine. FIG. 3 shows the different loading states of the partial widths 22a, 22b of the idling section as well as the opening states of the feed rate limiters 24a, 24b while performing a headland turning operation.

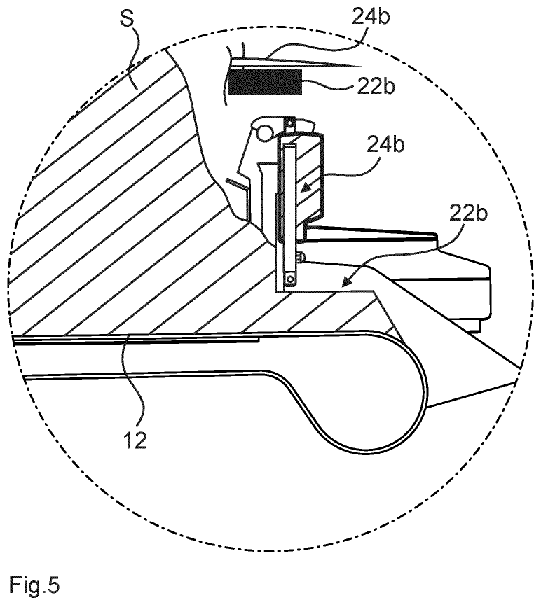

When approaching the headland lane, the partial widths 22a, 22b of the idling section are initially continuously and uniformly loaded with spreading material S and the feed rate limiters 24a, 24b are in an open state. FIG. 5 shows the loading state of the partial width 22b of the idling section and the opening state of the feed rate limiter 24b in detail.

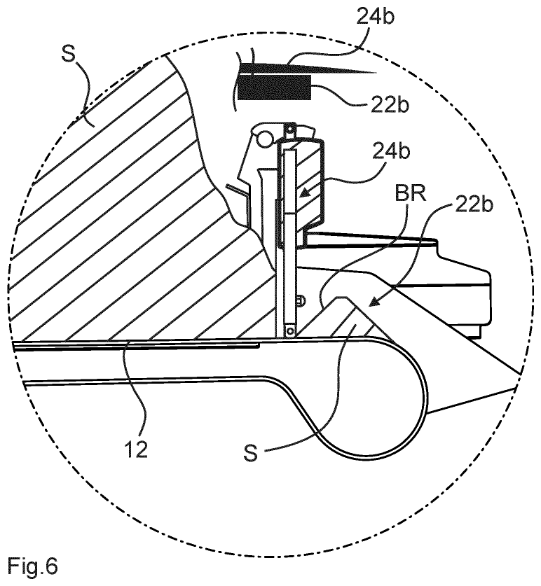

When approaching the headland lane, the control device 30 initiates the closing of the feed rate limiters 24a, 24b in good time before reaching a shut-off location AO on the agricultural land. The closing operation is initiated by the control device 30 at a closing time. FIG. 6 shows the loading state of the partial width 22b of the idling section and the closed feed rate limiter 24b in detail. From the illustration, it can be seen that the conveyed quantity of spreading material S on the partial width 22b of the idling section has a loading ramp BR, which is obtained due to the movement of the conveyor belt 12 with simultaneous closing movement of the feed slide 26b of the feed rate limiter 24b.

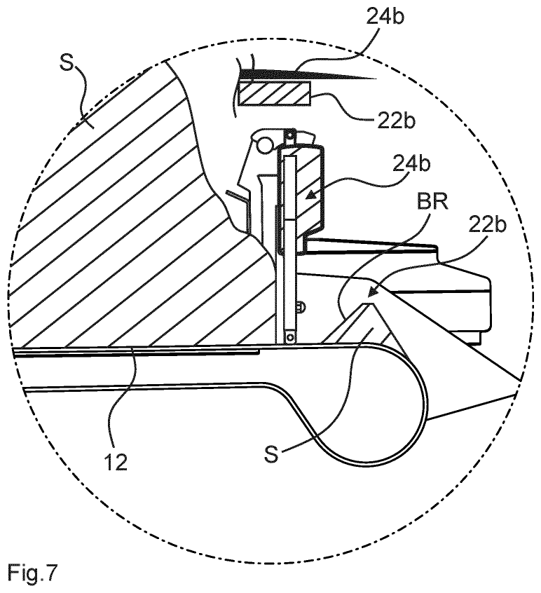

When the headland lane is approached further, both feed rate limiters 24a, 24b are then already closed, so that the feed of spreading material S into the partial widths 22a, 22b of the idling section is prevented. The partial widths 22a, 22b of the idling section therefore run synchronously empty before reaching the shut-off location AO. The idling situation is shown in detail in FIG. 7.

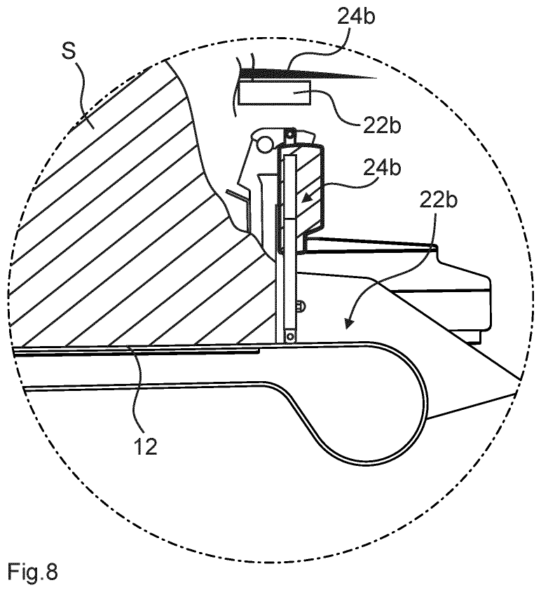

When the shut-off location AO is reached before the headland lane, both partial widths 22a, 22b of the idling section are completely empty, so that the turning operation is carried out with an unloaded idling section 20. FIG. 8 shows the partial width 22b of the idling section in detail.

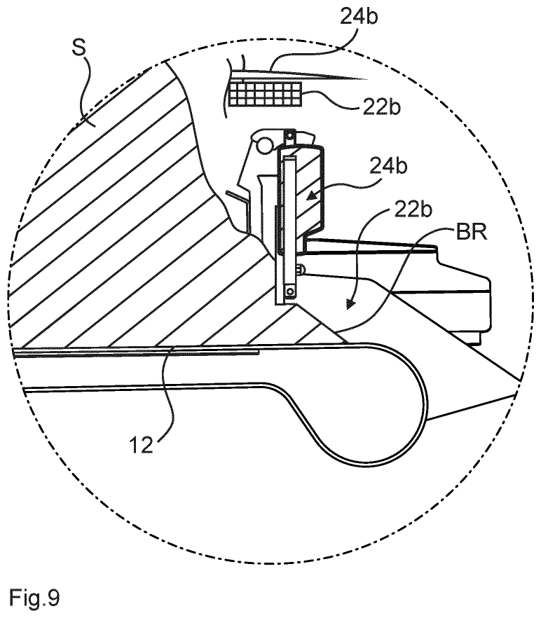

After the turning operation has been carried out, the partial widths 22a, 22b of the idling section are filled again with spreading material S by opening the feed rate limiters 24a, 24b in good time before the switch-on location EO is reached. FIG. 9 shows the filling process of the partial width 22b of the idling section in detail. Due to the opening process of the feed rate limiter 24b, a loading ramp BR again is obtained on the partial width 22b of the idling section.

The control device 30 calculates the closing time for the feed rate limiters 24a, 24b when approaching the headland and the opening time for the feed rate limiters 24a, 24b when leaving the headland as a function of an intended travel speed until the shut-off location AO or the switch-on location EO is reached.

FIG. 4 shows a spreading situation with the spreading boundary of the agricultural area running diagonally to the direction of travel. In this spreading situation, the partial widths 22a, 22b of the idling section run asynchronously empty. Initially, the partial widths 22a, 22b of the idling section are both completely and uniformly loaded with spreading material S and the feed rate limiters 24a, 24b are in an open state. When approaching the headland lane, the feed rate limiter 24b at the outer curve side is closed first, so that the partial width 22b of the idling section runs empty when approaching the headland lane further. With a time delay, the feed rate limiter 24a on the inside of the curve is then closed so that the partial width 22a of the idling section runs empty as the headland lane is approached further. Thus, the control device 30 causes the feed rate limiter 24b to close early before the shut-off location AO1 is reached, and causes the feed rate limiter 24b to close early before the shut-off location AO2 is reached. During the turning operation, both partial widths 22a, 22b of the idling section are then completely idle.

When driving out of the headland, the feed rate limiter 24b at outer curve side is opened first so that the partial width 22b of the idling section at the outer curve side is fed with spreading material S. The feed rate limiter 24a at the inner curve side is then opened after a time interval so that the partial width 22a of the idling section at the inner curve side is filled with spreading material S. The feed rate limiter 24a at the inner curve side is then opened at a time interval so that the partial width 22a of the idling section at the inner curve side is fed with spreading material S. The opening of the feed rate limiter 24b is thus initiated in good time before the switch-on location EO1 is reached. The opening of the feed rate limiter 24a is initiated in good time before the switch-on location EO2 is reached.

As a result of the fact that in the spreading situations shown in FIGS. 3 and 4 no spreading material S is provided on the idling section 20 during the turning operation, there is no risk of spreading material S unintentionally falling onto the spreading discs 16a, 16b during bumpy driving. Furthermore, it is prevented that spreading material S lies on the wrong side of the idling section 20 during an intended continuation of discharging of spreading material after or during a turning operation, so that no unintended local excessive spreading of spreading material, for example fertilizer, takes place in the area inside the curve when carrying out turning operations.

### LIST OF REFERENCE SIGNS

10 Spreading system
12 Conveyor belt
14a, 14b Guide body
16a, 16b Spreading discs
18 Feed-rate-setting device
20 Idling section
22a, 22b Partial widths of the idling section
24a, 24b Feed rate limiter
26a, 26b Feed slider
28a, 28b Slide drives
30 Control device
AE Ejection plane
AO, AO1, AO2 Shut-off locations
BR Loading ramp
EO, EO1, EO2 Switch-on locations
LA Longitudinal section
ME Rate setting plane
S Spreading material

1. A method for controlling an agricultural spreading machine during discharging of spreading material on an agricultural land, comprising:
feeding, using a conveyor of the spreading machine, the spreading material to be discharged along an idling section relating to a longitudinal section of the conveyor belt, the idling section being located between a rate setting plane, in which the feed rate of spreading material entering the idling section is set by a feed-rate-setting device of the spreading machine, and an ejection plane, in which the feed rate of spreading material leaving the idling section is ejected from the conveyor belt in the direction of a first and a second spreading disc wherein a control device for temporarily interrupting discharging of spreading material at a shut-off location on an agricultural area causes the feed-rate-setting device to prevent feeding of the spreading material into the idling section before the shut-off location is reached, so that the idling section of the conveyor belt runs empty when the shut-off location is reached.

2. The method according to claim 1, wherein the control device for continuing discharging at a switch-on location on the agricultural area causes the feed-rate-setting device to trigger the feeding of the spreading material into the idling section in advance of reaching the switch-on location, so that the conveyor belt is loaded with the spreading material over at least a partial width along the entire idling section when the switch-on location is reached.

3. The method according to claim 1, wherein
the spreading material leaving the idling section and located on a first partial width of the idling section is ejected from the conveyor belt in the ejection plane in a direction of a first spreading disc of the spreading machine; and/or
the spreading material leaving the idling section and located on a second partial width of the idling section is ejected from the conveyor belt in the ejection plane in a direction of a second spreading disc of the spreading machine.

4. The method according to claim 1,
wherein:
the feed-rate-setting device in the rate setting plane sets the feed rate of the spreading material entering a first partial width of the idling section by a first feed rate limiter; and/or
the feed-rate-setting device in the rate setting plane sets the feed rate of the spreading material entering a second partial width of the idling section by a second feed rate limiter.

5. The method according to claim 4, wherein at a spreading boundary of the agricultural area extending at right angles to a direction of travel of the spreading machine, the control device, upon temporary interruption of the discharging of the spreading material at the shut-off location on the agricultural area, simultaneously causes the first feed rate limiter and the second feed rate limiter of the feed-rate-setting device to close at a common closing time so as to prevent the discharging of the spreading material into the first partial width of the idling section and the second partial width of the idling section at an early stage before the shut-off location is reached, so that the first partial width of the idling section and the second partial width of the idling section synchronously run empty before the shut-off location is reached.

6. The method according to claim 4, wherein, at a spreading boundary of the agricultural area extending obliquely to the direction of travel of the spreading machine, the control device, upon temporary interruption of the discharging of the spreading material at the shut-off location on the agricultural area, causes the first feed rate limiter of the feed-rate-setting device to close at a first closing time and the second feed rate limiter of the feed-rate-setting device to close at a second closing time with a time delay from one another, before reaching the shut-off location to prevent feed of the spreading material into the first partial width of the idling section and the second partial width of the idling section, so that the first partial width of the idling section and the second partial width of the idling section run empty asynchronously before reaching the shut-off location.

7. The method according to claim 5, wherein that the control device calculates the common closing time, the first closing time and/or the second closing time as a function of an intended travel speed until the shut-off location is reached.

8. The method according to claim 4, wherein the first feed rate limiter and the second feed rate limiter of the feed-rate-setting device respectively perform a closing operation which extends in time over a closing period, so as to prevent feed of the spreading material into the first partial width of the idling section and the second partial width of the idling section, wherein
the feed rate of the spreading material entering the first partial width of the idling section decreases due to the closing operation of the first feed rate limiter during the closing period of the first feed rate limiter; and/or
the feed rate of the spreading material entering the second partial width of the idling section drops due to the closing operation of the second feed rate limiter during the closing period of the second feed rate limiter.

9. The method according to claim 8, wherein the control device adapts the belt speed of the conveyor belt during the closing operation of the first and/or the second feed rate limiters to the falling feed rate of the spreading material on the first partial width of the idling section and/or the second partial width of the idling section.

10. The method according to claim 1, wherein the feed-rate-setting device adjusts the feed rate of the spreading material entering the idling section by blocking the free feed cross-section above the conveyor belt.

11. A spreading system for discharging spreading material on an agricultural area, comprising
a first and a second spreading disc;
a conveyor belt for feeding the spreading material to be discharged along an idling section relating to a longitudinal section of the conveyor belt, said idling section being located between a rate setting plane and an ejection plane, said conveyor belt being configured to eject the conveyed quantity of the spreading material, which leaves the idling section, in the ejection plane in the direction of the first and the second spreading discs; and
a feed-rate-setting device configured to set the feed rate of the spreading material entering the idling section in the quantity setting plane, wherein a control device configured to cause the feed-rate-setting device to temporarily interrupt the discharging of the spreading material at a shut-off location on the agricultural area so as to prevent the spreading material from being fed into the idling section early before the shut-off location is reached, so that the idling section of the conveyor belt has run empty when the shut-off location is reached.

12. A spreading system according to claim 11, wherein the spreading system is configured to perform the method of controlling an agricultural spreading machine during the discharging of the spreading material onto an agricultural area according to claim 1.
